(19) United States
(12) Patent Application Publication
(10) Pub. No.: US 2023/0410031 A1
(43) Pub. Date: Dec. 21, 2023

(54) METHOD AND SYSTEM FOR TAKING ACTION BASED ON PRODUCT REVIEWS

(71) Applicant: Shopify Inc., Ottawa (CA)

(72) Inventors: Simona-Elena Manole, Berlin (DE); Leonardo Font Garcia, Barcelona (ES); Michael Hellicar, Angus (GB)

(21) Appl. No.: 17/827,890

(22) Filed: May 30, 2022

(51) Int. Cl. G06Q 10/08; G06Q 30/02; G06F 40/30; G06F 40/205

(52) U.S. Cl. CPC G06Q 10/0834; G06Q 30/0282; G06F 16/951; G06F 40/205; G06F 40/30

(57) ABSTRACT

A computer-implemented method including parsing product reviews received by a merchant, the parsing causing comments to be grouped into buckets; determining that an action threshold has been reached for a bucket; and responsive to the action threshold having been reached for the bucket, identifying an action based on the bucket; and performing the action at an electronic storefront for the merchant.

### FIELD OF THE DISCLOSURE

The present disclosure relates to electronic transactions, and in particular relates to performing actions automatically responsive to comments and reviews related to electronic commerce transactions.

### BACKGROUND

A merchant, storefront, electronic commerce platform, among others, may allow customers to leave reviews about the products or services that the merchant sells. For large storefronts, this may result in thousands or hundreds of thousands of reviews, spanning different product categories. Further, such reviews may be directed to various aspects of the sales process, from a review of the product itself, a review of the merchant storefront, a review of the shipping and delivery of the product, a review of customer interactions with the merchant, among other such feedback.

In some cases, customer feedback forms may allow the selection of the type of feedback being supplied. However, implementing customer feedback forms as a single text field has a higher conversion rate than more complicated multi-step forms asking about different topics or aspects of the product and product purchasing experience.

### SUMMARY

Once feedback is received, it is difficult for merchants to know what to do in response to product reviews. This is of particular concern with a large volume of reviews and a large number of different products.

In this regard, the present disclosure relates to the performance of an action based on feedback received by a merchant. In particular, a computing system may parse or analyze a stream of reviews and comments, and may categorize statements within each review or comment based on its context. The categories may be referred to as “buckets”, and the reviews may be placed in such buckets.

Once a bucket has a number of reviews that overcome a threshold, a review of the merchant site may be performed, and an action automatically taken, where such action may in some cases include confirmation with a merchant.

In one aspect, a computer-implemented method may be provided. The method may include parsing product reviews received by a merchant, the parsing causing comments to be grouped into buckets. The method may further include determining that an action threshold has been reached for a bucket, and responsive to the action threshold having been reached for the bucket, identifying an action based on the bucket. The method may further include performing the action at an electronic storefront for the merchant.

In some embodiments, the parsing may use natural language processing on the comments.

In some embodiments, the parsing may determine a sentiment for the comments.

In some embodiments, the buckets may be dynamically created based on the parsing.

In some embodiments the identifying the action may comprise analyzing the storefront for the merchant.

In some embodiments, the method may further comprise, prior to performing the action, providing an indication of the action to the merchant; and obtaining a confirmation that the action should be performed, wherein the action is performed at the electronic storefront for the merchant responsive to the obtaining the confirmation.

In some embodiments, the comments may be from verified customers. In some of these embodiments, the method may further comprise analyzing historic comments for a verified customer; determining a weighting factor based on the analysis of the historic comments; and applying the weighting factor to a new comment from the verified customer when grouping the comment into a bucket.

In some embodiments, the method may further comprise dynamically adjusting the actionable threshold based on comments in a second storefront for a product.

In some embodiments, the actionable threshold may be based on a number of negative comments compared to a number of a product sold by the merchant.

In some embodiments, the actionable threshold may be a number of negative comments regarding shipping to a particular geographic area compared to a total number of products shipped to the particular geographic area.

In some embodiments, the action may be to change a method of shipping to the particular geographic area.

In some embodiments, the action may comprise adding or adjusting a sizing chart for a clothing product.

In a further aspect, a computing device having a processor and a communications subsystem may be provided. The computing device may be configured to parse product reviews received by a merchant, the parsing causing comments to be grouped into buckets. The computing device may further be configured to determine that an action threshold has been reached for a bucket, and responsive to the action threshold having been reached for the bucket, identify an action based on the bucket. The computing device may further be configured to perform the action at an electronic storefront for the merchant.

In some embodiments, the computing device may be configured to parse using natural language processing on the comments.

In some embodiments, the computing device may be configured to determine a sentiment for the comments while parsing.

In some embodiments, the buckets may be dynamically created based on the parsing.

In some embodiments, the computing device may be configured to identify the action by analyzing the storefront for the merchant.

In some embodiments, the computing device may further be configured to, prior to performing the action, provide an indication of the action to the merchant and obtain a confirmation that the action should be performed, wherein the action is performed at the electronic storefront for the merchant responsive to obtaining the confirmation.

In some embodiments the comments may be from verified customers. In some of these embodiments the computing device may be further configured to analyze historic comments for a verified customer, determine a weighting factor based on the analysis of the historic comments, and apply the weighting factor to a new comment from the verified customer when grouping the comment into a bucket.

In a further aspect, a non-transitory computer readable medium for storing instruction code may be provided. The instruction code, when executed by a processor on a computing device, may cause the computing device to parse product reviews received by a merchant, the parsing causing comments to be grouped into buckets. The instruction code, when executed by a processor on a computing device, may further cause the computing device to determine that an action threshold has been reached for a bucket, and responsive to the action threshold having been reached for the bucket, identify an action based on the bucket. The instruction code, when executed by a processor on a computing device, may further cause the computing device to perform the action at an electronic storefront for the merchant.

### BRIEF DESCRIPTION OF THE DRAWINGS

The present disclosure will be better understood with reference to the drawings, in which:

FIG. 1 is a block diagram showing an example e-commerce system capable of implementing the embodiments of the present disclosure.

FIG. 2 is a block diagram showing an example interface for a merchant using the e-commerce platform of FIG. 1.

FIG. 3 is a process diagram showing a process for creating actions based on parsing of reviews.

FIG. 4 is a block diagram showing a simplified computing device capable of being used with the embodiments of the present disclosure.

### DETAILED DESCRIPTION

The present disclosure will now be described in detail by describing various illustrative, non-limiting embodiments thereof with reference to the accompanying drawings. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

In accordance with the embodiments of the present disclosure, methods and systems for parsing or analyzing a stream of reviews and comments are provided. This system may categorize each review or comment based on its context.

Once a bucket has a number of reviews that overcome a threshold, a review of the merchant site may be performed, and an action undertaken.

Each is described below.

An Example E-Commerce Platform

Although integration with a commerce platform is not required, in some embodiments, the methods disclosed herein may be performed on or in association with a commerce platform such as an e-commerce platform. Therefore, an example of a commerce platform will be described.

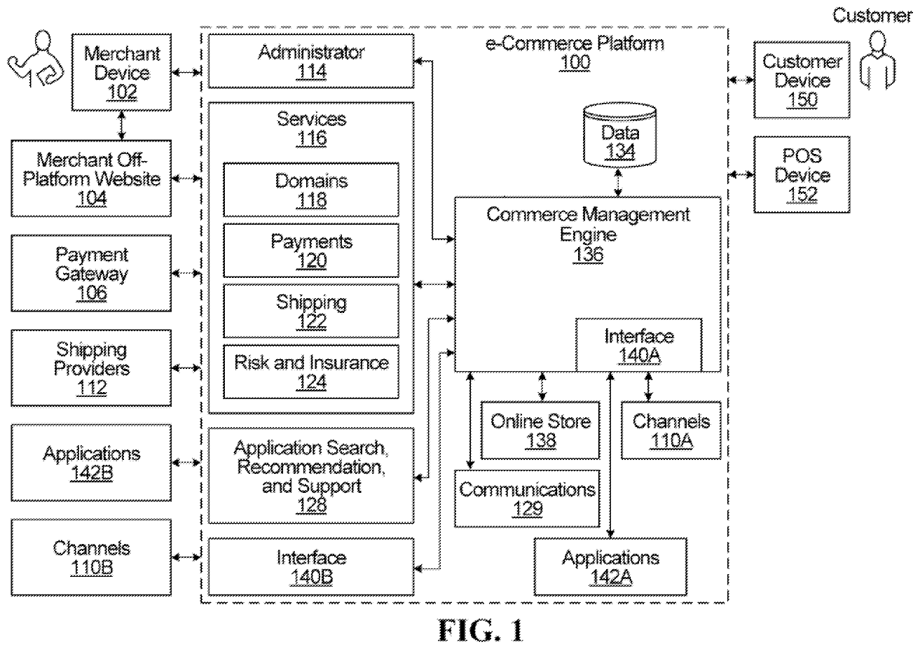

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

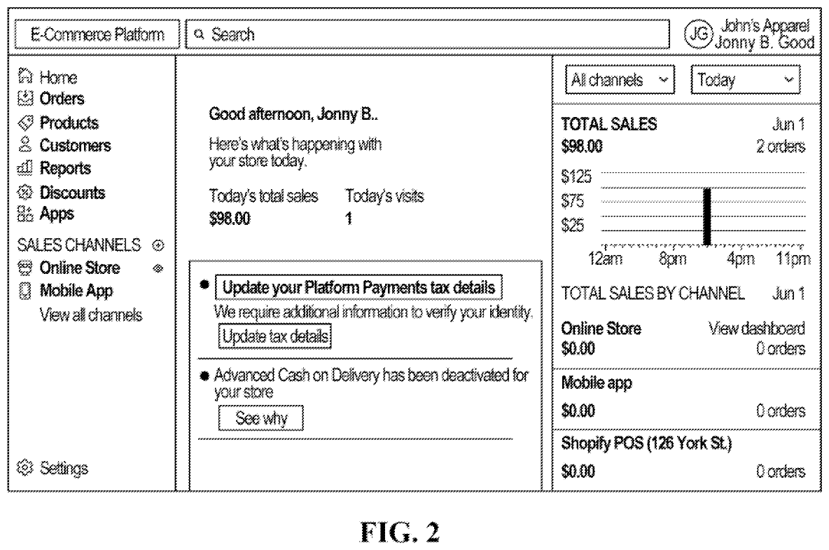

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

Performing Actions Based on Reviews/Comments

Utilizing an ecommerce platform such as the one described with regard to FIGS. 1 and 2 above, a merchant may have the ability to receive product reviews from customers for products that were purchased by such customers. For example, this may be part of an interactive user experience during the checkout process. In other cases, the customer review may be received after product purchase and delivery has occurred. For example, this may occur based on a solicitation by the merchant to the customer for a review, such as by sending a review link to the customer. Other options are possible.

In other cases, comments may also be applicable to embodiments of the present disclosure. Specifically, a customer or potential customer may leave comments regarding the purchasing experience, website, product, among other options. The disclosure below uses product reviews as an example. However, this is not limiting, and any type of comments could be used in some embodiments of the present disclosure.

In some embodiments, the customer leaving the product review may be a verified customer. Specifically, the customer may have login credentials to the merchant or e-commerce platform and in this regard, the purchases by the customer and the reviews left by the customer can be verified to belong to the customer. The product review may be associated with a particular purchase or transaction and the e-commerce platform has recorded various details of that transaction such as products purchased, date and time, shipping method, shipping source and destination, and other various details. As described below, the verification of the customer can be utilized in the present system with regard to the actions taken by the system.

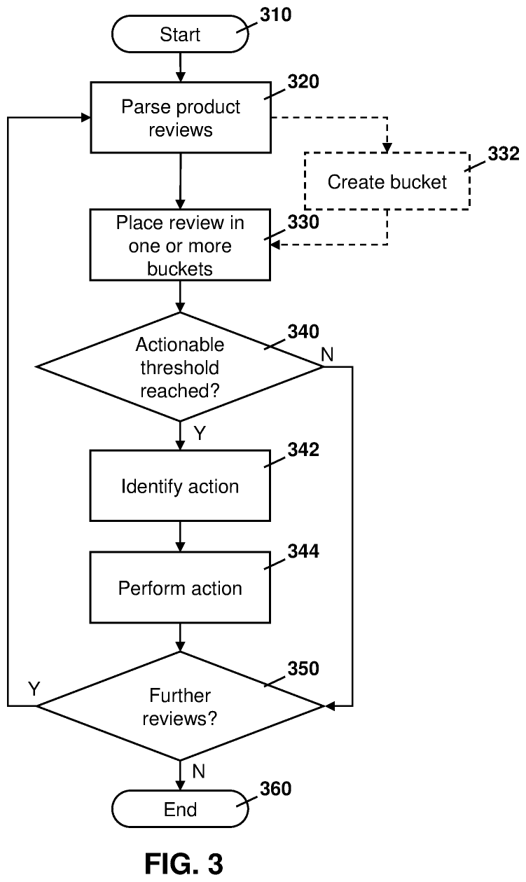

Reference is now made to FIG. 3. In the embodiment of FIG. 3, the process starts at block 310 and proceeds to block 320 in which product reviews may be parsed. In some cases, product reviews may be parsed at the time that the review is left. In some cases, product reviews can be batch processed, for example when computing resources are available. In other cases, some combination of batch processing and real-time processing could be implemented.

The parsing at block 320 may be performed in a variety of ways. In one case, a computing system may parse the text of the comment or review to extract different topics using natural language processing techniques.

In other cases, keywords or phrases can be utilized for the parsing and word classification techniques may be utilized. In other cases, clustering techniques may be utilized. In some embodiments, machine learning techniques may be used. Other options are possible.

For example, Named Entity Recognition is one technique in which tags within text can be extracted for further analysis.

In some cases, Text Summarization may be used where technical terms can be broken into more basic terms to aid in the natural language processing.

In some cases, text classification can be used for parsing. Text classification may include topic modeling, sentiment analysis, and keyword extraction, among other techniques.

In some cases, topic modeling may be utilized. Topic modeling is an unsupervised natural language processing technique that allows for the grouping of common topics through the use of artificial intelligence.

The parsing may further determine the sentiment related to those topics, for example utilizing sentiment analysis. Sentiment analysis may parse data such as text, audio, among other inputs, to determine whether such input is positive, neutral or negative in some cases.

In some cases, keyword extraction may be used. Keyword extraction may automatically extract the most relevant information from an input, for example utilizing artificial intelligence and machine learning algorithms.

In some cases, lemmatization and stemming may be used for parsing. Specifically, text may be broken down, tagged and restructured to create a root stem or definition.

In other cases, morphological segmentation may be used for the parsing to put words into their simplest forms, or morphemes.

In some cases, a grammatical analysis referred to as a “parse tree” may be made for a given sentence to determine relationships between words.

Other options for parsing are possible, and the present disclosure is not limited to any particular parsing technique.

The analyzed review or comment may then be grouped, categorized, placed in a bucket, sorted by theme, among other similar sorting techniques.

Specifically, referring to FIG. 3, the process proceeds from block 320 to block 330 in which the review may be categorized or placed in a “bucket”. As used herein, the term “bucket” refers to a grouping or mapping for similar reviews.

Such buckets or groups may be predefined in some cases, or created as needed in some cases. If buckets can be dynamic and the parsing determines that the product review or comment belongs in a bucket that does not yet exist, the process may optionally proceed from block 320 to block 332 in which the bucket is first created, before proceeding to block 330 in which the review may be classified or placed in one or more buckets.

Examples of buckets may include product quality, shipping experience, shopping experience, support experience, size accuracy, color accuracy, among others.

Thus, for example, if the review pertains to the shipping time being longer than expected, such review may be classified into the “shipping experience” bucket.

In some cases, the review may pertain to more than one topic and may therefore be classified into more than one bucket. For example, if the review states that shipping took longer than expected and the product did not fit correctly then the review may be classified both into the “shipping experience” bucket and the “clothing fit” bucket.

A level of granularity for the various buckets can be set at a computing system. Thus, in some cases a shirt fitting too small may be classified into a “product quality” bucket. However, in other cases “product quality” may be too general and product quality may instead be represented with two or more buckets. In some cases, the buckets may be defined individually for each merchant. In some cases, buckets may be defined for an entire ecommerce platform.

The product being reviewed may be identified in various ways. As indicated above, in some cases the customer leaving the review may be a verified customer. For example, the customer may have logged in with login credentials and therefore can be identified. Further, the customer's purchasing history may be known to the merchant or ecommerce platform and therefore the review can be correlated to the purchase history from the customer.

In other cases, the review may be left at a particular location on the merchant's electronic storefront in which a particular product is identified.

In other cases, the review may include information that the parser could use to identify the product.

Therefore, in some cases, the review being placed in the bucket at block 330, may include information with regard to the particular product to which the review relates.

Further, the placing of the review into a bucket at block 330 may use various thresholds. If, for example, a defined number of buckets exist, then the choice of bucket at block 330 may be the bucket with the highest probability that the review falls into. For example, after parsing the review, the review may be given a probability for each of the plurality of buckets that it belongs in such bucket. In this case, the review may be assigned to the bucket having the highest probability score.

In some cases, the probability that the review falls within the bucket must meet a threshold level in order for the review to be placed in the bucket. For example, if the threshold is not met, the review may be determined to not fall into a bucket and may be discarded in some cases.

In the case where buckets may be created at block 332, the probability that the review falls within an existing bucket may need to be below a threshold value, indicating that the review does not fall within any existing buckets, prior to the new bucket being created. The new bucket being created at block 332 may be provided with a topic based on the parsing of the review in question.

In some cases, the review may fall into more than one bucket and in these cases, the threshold probability that the review falls within two or more buckets could exceed a threshold. Thus, in the case where the review may include two topics, each of those topics having buckets, then the probability that the review falls into the two buckets may exceed the threshold required for the review to be placed into each bucket.

In some cases, inauthentic reviews may be removed. In some cases the inauthentic reviews are flagged as inauthentic and viewable to the merchant, but not viewable to buyers. In some cases, reviews flagged as inauthentic prior to block 320 are excluded from parsing at block 320. In some cases, the parsing at block 320 may coexist with or be part of the same parsing process that detects inauthentic reviews.

Other options are possible.

Once a review has been placed into one or more buckets, the process proceeds from block 330 to block 340 in which a check is made to determine whether an actionable threshold has been reached for any bucket. Specifically, the check at block 340 may occur after each review has been placed into a bucket, or may occur after a threshold number of reviews have been sorted into buckets, or may occur at a particular time or with a particular interval, among other options.

The computing system may analyze each bucket to look for trends. Outliers may trigger an action at the computing system. Specifically, trends may be used to correlate changes in customer sentiment to actions the merchant took in the past. Trends can be across products in the shop to highlight to the merchant which products have higher customer satisfaction. Trends can be over time to show if customer satisfaction has improved or declined. Sentiment can be charted on a map to display different sentiments in different geographical regions. Outliers can be highlighted to merchants with actions, as described below.

In some cases, the threshold may be based on a percentage of negative reviews when compared with a number of products sold. For example, a merchant may know how many of a specific product has been sold and if reviews for that product have a certain percentage that state that the product does not fit correctly, this may indicate that an action needs to be taken.

In other cases, if a certain number of negative reviews are placed into a bucket, this may trigger an action. In this case the actionable threshold may simply be a defined number of negative reviews.

In some cases, the profile of the user leaving the review may be taken into account when performing the analysis at the bucket. Specifically, the customer leaving the review may be a verified customer and, in this case, the customer's past reviews may be taken into account. For example, if the customer typically leaves good reviews and, in this case, leaves a poor review, such poor review may be given more weight. Conversely, if the customer consistently leaves negative reviews, the weight of such review in the analysis of the bucket may be given less weight. Other options are possible.

Thus, the review may be added to other reviews in the bucket, but a weighting factor may be applied to the review to make the review count for more or less, depending on the customer leaving the review, when determining whether the actionable threshold has been reached.

In some cases, where the computing system is part of an ecommerce platform, product reviews from multiple storefronts may be compared to find trends when analyzing the bucket, and in this case, a threshold to take action may be changed (e.g. reduced) if the negative reviews are trending for the product across multiple storefronts, for example. Thus, if a typical bucket needs ten negative reviews to meet an actionable threshold, if the product is trending negatively in reviews across multiple storefronts, the threshold may for example be lowered to six. In other cases, if a percentage of negative reviews to products sold must be at three percent for action to be taken, if the product is receiving negative reviews in other storefronts the percentage may be lowered to two percent, for example, in order for the actionable threshold to be met.

Other options for actionable thresholds are possible.

From block 340, if the actionable threshold is met, the process proceeds to block 342 in which an action may be identified to be performed based on the bucket, the nature of the reviews, among other options. From block 342 the process proceeds to block 344 in which the action is performed.

In some cases, the action may involve fixing parameters on the storefront. For example, if a number of reviews indicate that a particular clothing item does not fit correctly then the action identified at block 342 may include checking whether a sizing chart is included with the product description and determining whether the sizing chart should be amended or corrected. For example, an incorrect sizing chart may have been placed in the storefront with regards to the particular product, and the check could determine that the sizing chart is incorrect. In this case, the process then proceeds to block 344 in which the action is performed. The action may involve replacing with the sizing chart, adding a sizing chart, or similar manipulation of the sizing chart with regard to the product.

In other cases, the action identified at block 342 may relate to the geographical location of the customer. For example, if the customer complains that shipping took longer than expected, a comparison for other negative reviews and the geographic locations of such negative reviews could indicate that the shipping company being used by the merchant for that particular geographic location is not achieving delivery time objectives. In this case, the process could proceed to block 344 in which the action may be to use a different shipping company when shipping to that particular geographic area.

In other cases, past actions which have led to positive customer experiences could be utilized as a source for identifying an action that can be taken now. In particular, actions and results can be stored in a database, and a machine learning algorithm could utilize such actions and results to process the current trend with regard to the reviews and determine a suitable action.

For example, a storefront may have many settings which could be manipulated or changed and the changing of one or more of these settings could lead to varied customer experiences. An artificial intelligence engine could correlate the changes to the customer feedback in order to identify an action at block 342 and then perform the action at block 344.

In some cases, the action identified at block 342 may require a confirmation from a merchant and, prior to performing the action at block 344, the merchant may need to approve the action.

In some cases, an action score could be provided with the identified action. If the action score exceeds a threshold the action may be automatically performed. If the action score is lower than the threshold, then the merchant may need to approve the action prior to it being implemented.

From block 344, the process proceeds to block 350 in which a check is made to determine whether any other reviews need to be parsed and sorted. Further, from block 340, if no actionable threshold has been met, the process also proceeds to block 350 in which a check is made to determine whether any other reviews need to be parsed and sorted into buckets.

At block 350, if other reviews need to be parsed, the process proceeds back to block 320 to parse such further reviews.

Conversely, at block 350, if no further reviews need to be parsed, the process proceeds from block 350 to block 360 and ends.

Shipping Example

The embodiment of FIG. 3 can be illustrated by various non limiting examples. In a first example, A customer may leave a review “This arrived so late but it is very comfortable”. In this case, the customer was a verified customer and the review can be associated with a particular sweater sold by the merchant. Specifically, in this case the review is associated with a particular transaction between the buyer and the merchant. This may be based on the parsing and the association of the review with the sweater itself, for example.

The parsing at block 320 could find that the customer had a poor shipping experience based on the words “this arrived so late”. The parsing at block 320 could further find that the product received a good product quality score based on the words “but it is very comfortable”.

In this case, the review may be placed, at block 330, in a bucket regarding shipping experience and a bucket regarding the product quality. Further, the bucket regarding shipping experience may relate to the storefront as a whole, may be sorted by geographical regions, shipping providers, fulfillment subcontractors among other options.

The bucket regarding product quality may relate to the sweater or clothing item itself, may relate to the source of the product, among other options. For example, in some cases, the review could be associated with the product object - a specific variant of the product, or all product variants (e.g. red, size XL variant). In some cases, the bucket may relate to a particular source/supplier for a product, and different products provided by such source/supplier can be grouped into such bucket. This may be based on a verified product in a transaction being associated with the review, and data on the source/supplier of such product.

Other options are possible.

A check at block 340 may then be made on the buckets to determine whether an actionable threshold has been met. In the case of the positive review this may not count towards any actionable threshold, but may tilt the trend in a positive direction for the merchant to review.

In the case of the shipping issue, assuming other shipping issues have occurred for that same geographic location, then the actionable threshold may be met. In this case, an action may be identified at block 342 and an action taken at block 344. The action may include, for example, sorting the shipping options on the checkout of the merchant in a different order, to prioritize other shipping methods. In other cases, the estimated delivery time could be adjusted for the particular shipping method to ensure customer expectations are met. In other cases, the particular shipping method could be phased out.

In some embodiments, prior to phasing out or changing shipping options, a confirmation may be provided to the merchant to approve such change.

Clothing Fit Example

In another example, a review may indicate: “Had to return — fit way too large”.

The parser at block 320 may determine that the review relates to the fit of a product and the customer had a poor experience based on having to return the product.

In this case, a bucket may exist for product fit, and the product may be correlated based on the verified sales for the customer, based on the review being made for a particular product, among other options.

In this case, a check may then be made to determine whether a certain number of negative reviews have been received for this product compared with the number of the product sold by the merchant. If the threshold is met, as determined at block 340 then an action may be identified at block 342.

In particular, in this case the product page on the merchant's site may be reviewed to determine whether a sizing chart exists on the site. If not, the action at block 344 may be to add a sizing chart to the product page on the merchant site.

If a sizing chart exists, a check may be made to determine if the correct sizing chart is included on the page. If not, the action may be to replace the sizing chart that is on the product page on the merchant's site with the correct sizing chart.

If the sizing chart is correct, then the action at block 344 may be to put a note under on the product page with the sizing chart indicating that the product fit is larger than indicated in the sizing chart.

Other options for actions are possible.

The addition, replacement or note added to the sizing chart could be an automatic action by a computing system in some cases. In other cases, the action may require approval by the merchant prior to being implemented on the merchant site.

While the shipping and sizing examples are provided for illustration, they are not limiting, and the process of FIG. 3 could be utilized for a variety of reviews and actions.

Computing Device

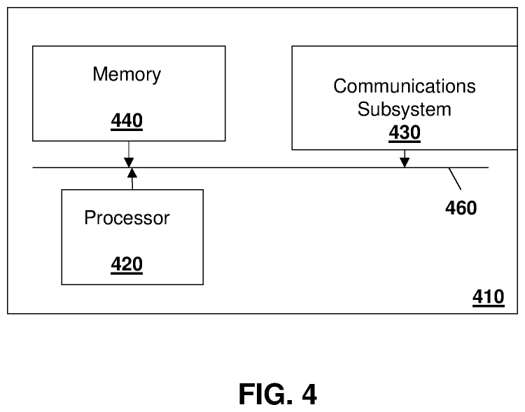

The above-discussed methods are computer-implemented methods and require a computer for their implementation/use. Such computer system could be implemented on any type of, or combination of, network elements or computing devices. For example, one simplified computing device that may perform all or parts the embodiments described herein is provided with regard to FIG. 4.

In FIG. 4, computing device 410 includes a processor 420 and a communications subsystem 430, where the processor 420 and communications subsystem 430 cooperate to perform the methods of the embodiments described herein.

The processor 420 is configured to execute programmable logic, which may be stored, along with data, on the computing device 410, and is shown in the example of FIG. 4 as memory 440. The memory 440 can be any tangible, non-transitory computer readable storage medium, such as DRAM, Flash, optical (e.g., CD, DVD, etc.), magnetic (e.g., tape), flash drive, hard drive, or other memory known in the art. In one embodiment, processor 420 may also be implemented entirely in hardware and not require any stored program to execute logic functions. Memory 440 can store instruction code, which, when executed by processor 420 cause the computing device 410 to perform the embodiments of the present disclosure.

Alternatively, or in addition to the memory 440, the computing device 410 may access data or programmable logic from an external storage medium, for example through the communications subsystem 430.

The communications subsystem 430 allows the computing device 410 to communicate with other devices or network elements. In some embodiments, communications subsystem 430 includes receivers or transceivers, including, but not limited to, ethernet, fiber, Universal Serial Bus (USB), cellular radio transceiver, a Wi-Fi transceiver, a Bluetooth transceiver, a Bluetooth low energy transceiver, a GPS receiver, a satellite transceiver, an IrDA transceiver, among others. As will be appreciated by those in the art, the design of the communications subsystem 430 will depend on the type of communications that the transaction device is expected to participate in.

Communications between the various elements of the computing device 410 may be through an internal bus 460 in one embodiment. However, other forms of communication are possible.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method comprising:
parsing product reviews received by a merchant, the parsing causing comments to be grouped into buckets;
determining that an action threshold has been reached for a bucket; and
responsive to the action threshold having been reached for the bucket, identifying an action based on the bucket; and
performing the action at an electronic storefront for the merchant.

2. The method of claim 1, wherein the parsing uses natural language processing on the comments.

3. The method of claim 2, wherein the parsing determines a sentiment for the comments.

4. The method of claim 1, wherein the buckets are dynamically created based on the parsing.

5. The method of claim 1, wherein the identifying the action comprises:
analyzing the storefront for the merchant.

6. The method of claim 1, further comprising, prior to performing the action:
providing an indication of the action to the merchant; and
obtaining a confirmation that the action should be performed,
wherein the action is performed at the electronic storefront for the merchant responsive to the obtaining the confirmation.

7. The method of claim 1, wherein the comments are from verified customers, the method further comprising:
analyzing historic comments for a verified customer;
determining a weighting factor based on the analysis of the historic comments; and
applying the weighting factor to a new comment from the verified customer when grouping the comment into a bucket.

8. The method of claim 1, further comprising dynamically adjusting the actionable threshold based on comments in a second storefront for a product.

9. The method of claim 1, wherein the actionable threshold is based on a number of negative comments compared to a number of a product sold by the merchant.

10. The method of claim 1, wherein the actionable threshold is a number of negative comments regarding shipping to a particular geographic area compared to a total number of products shipped to the particular geographic area.

11. The method of claim 10, wherein the action is to change a method of shipping to the particular geographic area.

12. The method of claim 1, wherein the action comprises adding or adjusting a sizing chart for a clothing product.

13. A computing device comprising:
a processor; and
a communications subsystem,
wherein the computing device is configured to:
parse product reviews received by a merchant, the parsing causing comments to be grouped into buckets;
determine that an action threshold has been reached for a bucket; and
responsive to the action threshold having been reached for the bucket, identify an action based on the bucket; and
perform the action at an electronic storefront for the merchant.

14. The computing device of claim 13, wherein the computing device is configured to parse using natural language processing on the comments.

15. The computing device of claim 14, wherein the computing device is configured to determine a sentiment for the comments while parsing.

16. The computing device of claim 13, wherein the buckets are dynamically created based on the parsing.

17. The computing device of claim 13, wherein the computing device is configured to identify the action by analyzing the storefront for the merchant.

18. The computing device of claim 13, wherein the computing device is further configured to, prior to performing the action:
provide an indication of the action to the merchant; and
obtain a confirmation that the action should be performed,
wherein the action is performed at the electronic storefront for the merchant responsive to obtaining the confirmation.

19. The computing device of claim 13, wherein the comments are from verified customers, the computing device further configured to:
analyze historic comments for a verified customer;
determine a weighting factor based on the analysis of the historic comments; and
apply the weighting factor to a new comment from the verified customer when grouping the comment into a bucket.

20. A non-transitory computer readable medium for storing instruction code, which, when executed by a processor on a computing device cause the computing device to:
parse product reviews received by a merchant, the parsing causing comments to be grouped into buckets;
determine that an action threshold has been reached for a bucket; and
responsive to the action threshold having been reached for the bucket, identify an action based on the bucket; and
perform the action at an electronic storefront for the merchant.
